(19) United States
(12) Patent Application Publication
(10) Pub. No.: US 2009/0271227 A1
(43) Pub. Date: Oct. 29, 2009

(54) METHODS AND SYSTEMS FOR MONETIZING EMPTY SPACE INVENTORY AS EMPTY ADJACENT SPACE

(76) Inventor: Michael Hayat, Foster City, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/428,390

(22) Filed: Apr. 22, 2009

Related U.S. Application Data
(60) Provisional application No. 61/125,300, filed on Apr. 24, 2008.

(51) Int. Cl. G06Q 10/00; G06Q 50/00; G06Q 30/00

(52) U.S. Cl. 705/6; 705/5; 705/26

(57) ABSTRACT

Methods and systems for facilitating the sale, lease, rental, or other monetization of unsold space inventory (e.g., seats, berths, cabins, rooms, etc.) to customers or passengers as guaranteed, empty adjacent space, after the passenger has already purchased a reservation and check-in has commenced. The empty adjacent space (EAS) may be sold as an upgrade when a guest checks-in at an event (e.g., an airline flight, theater performance, train trip, bus trip, hotel stay, day at the beach, parking space lease, etc.) or some time thereafter.

### RELATED APPLICATIONS

This is a NONPROVISIONAL and claims the priority benefit of U.S. Provisional Patent Application 61/125,300, filed Apr. 24, 2008, which is incorporated herein by reference.

### FIELD OF THE INVENTION

The present invention relates to methods and systems to sell, lease, rent, or otherwise monetize unsold space inventory (e.g., seats, berths, cabins, rooms, etc.) to customers or passengers as guaranteed, empty adjacent space, after the passenger has already purchased a berth or similar reservation at check-in time.

### BACKGROUND

Frequent flyers, train passengers, theatre goers, hotel guests, and others have all experienced the joy of having an unoccupied seat or room next to them when traveling or spending an evening enjoying a movie or live performance. So too have these individuals experienced the discomfort of being seated or housed next to a stranger in a cramped environment such as an airplane, train or theatre. The situation is aggravated if the person occupying the adjacent seat or room intrudes upon the personal space of the passenger or theatre patron, does not follow social customers appropriate for the venue, or creates loud noises or other disturbances (e.g., in an adjacent hotel room or ship cabin).

Empty adjacent seats are not just a luxury. In a 2002 article, Shirley Streshinsky reported that airline passengers who had the good fortune to sit next to an unoccupied seat for a flight felt that delays were shorter, meals were hotter and drinks colder. S. Streshinsky, “Airline Seat Space: Cruel and Unusual Punishment?”, Via Magazine, September 2002. Thus, it seems that travelers' attitudes regarding unrelated aspects of their journeys are dramatically impacted by the availability of “elbow room”.

However, travelers, theatre patrons and hotel guests cannot, at present, guarantee that they will have an unoccupied adjacent space, even when unsold space is available. In the case of airline seats, for example, unless a passenger is willing to purchase an adjacent seat at the time of his or her initial reservation, the passenger has no guarantee that the adjacent seat will be unoccupied at the time of travel. So at present the passenger must make the purchase decision at reservation time and must pay a significant price for the unoccupied seat. In some instances, even the purchase of the extra seat may not guarantee that it will be located adjacent to the one the passenger will occupy (e.g., it could be located across an aisle). Thus, today it is often just a result of chance or good fortune that a passenger or customer enjoys the benefit of an unoccupied adjacent space.

U.S. Patent Application Publication 2007/0250356, entitled Seat Reservation System and Process, describes a seat reservation system to allocate one or several conditional adjacent empty seat(s) to passengers when making reservations for a flight. There is no discussion of providing for the sale of empty adjacent seats as passengers check in. Further, there is no provision for cost sharing among multiple passengers with reserved seats adjacent to a common, empty seat.

U.S. Pat. No. 6,715,716, entitled Economy Aircraft Sleeper Seat, describes an airline seat with an adjustable back portion that can be moved so as to allow a passenger in an immediately rearward seat to recline by placing his or her feet through the resulting opening and rest them on the seat cushion. There is no discussion of providing a guarantee of empty adjacent seats.

Japanese patent application publications JP 2004-171455 and JP 51-74212 each describe systems which permit users to purchase unoccupied seats on a train in the post-reservation, post-check-in time frame. However, these references describe systems for the purchase of empty seats to be occupied by the person making the purchase (or someone for whom the purchase is being made). The seats are not intended to remain unoccupied during the trip. Further, there is no provision for cost-sharing among several passengers with reserved seats adjacent to a common, empty seat.

Japanese patent application publication JP 2005-309557 describes a method for reserving a parking space. There is no provision for offering the purchase or lease of an unoccupied, adjacent parking space at the time the driver checks-in his or her vehicle.

### SUMMARY OF THE INVENTION

In accordance with embodiments of the present invention, following expiration of a time period for guests to purchase assigned space for an event, a determination is made as to whether or not any empty adjacent space (EAS) for the event exists. If so, the EAS is offered for purchase by one or more guests holding assigned space for the event so as to guarantee that the EAS remains unoccupied during at least a portion of the event. The EAS may be any of the following: a seat, a berth, a room, a cabin, a parking space, a designated space for a passenger on a vehicle, a designated space for personal property, or a designated space in a building. The event may be any of the following: a voyage, a flight, a lease term, a theatre performance, a hotel stay, and a period of occupancy of an assigned space. In some cases, a common EAS area for the event may be offered to multiple ones of the one or more guests for purchase. More generally, the EAS may be offered for purchase according to business rules established by the operator of the event.

In some instances, the determination as to whether or not any previously unsold space is available for sale as EAS at the event occurs after a check-in process for the event has commenced. The EAS may be laterally adjacent to an assigned space for at least one of the one or more guests. Alternatively, or in addition, the EAS may be in front of, behind, above or below such assigned space(s).

Following its purchase, the EAS may be repurposed or reconfigured from its original state. This may include subdividing purchased EAS for use by those of the one or more guests making such purchases. In addition, the purchased EAS may be so designated, in order to further guaranty that the purchased EAS remains unoccupied.

These and other features of the present invention are described in detail below.

### BRIEF DESCRIPTION OF THE DRAWINGS

The present invention is illustrated by way of example, and not limitation, in the figures of the accompanying drawings, in which:

FIG. 1 is a block diagram illustrating an exemplary computer system upon which an embodiment of the invention may be implemented.

FIG. 2 is a flow diagram showing an exemplary embodiment of the invention, as for example may be used in connection with the sale of EAS associated with an airline flight or other event.

FIGS. 3A-3C illustrate examples of EAS in aircraft seating configurations and show how pricing different EAS opportunities may derive revenues of different amounts for various configurations of EAS locations.

### DETAILED DESCRIPTION

The present methods and systems facilitate the sale, lease, rental, or other monetization of unsold space inventory (e.g., seats, berths, cabins, rooms, etc.) to customers or passengers as guaranteed, empty adjacent space (EAS), after the passenger has already purchased a seat or similar reservation and is checking-in. This has the ability to increase operator revenue with a new revenue stream (the empty adjacent space yield or EASY) while also increasing guest (passenger, spectator, occupant, etc.) comfort. The EAS may be sold as an upgrade when a guest checks-in at an event (e.g., an airline flight, theater performance, train trip, bus trip, hotel stay, day at the beach, parking space lease, etc.).

Guaranteed empty adjacent space will both increase guests' physical comfort, guests' privacy and reduce guests' stress levels. Moreover, the invention improves upon conventional approaches to monetizing empty seats (i.e., which involve selling more seats to more passengers), which approaches may increase operators' revenue but at the same time also increase their variable costs as the operators must expend additional resources to serve those extra guests. The present invention provides opportunities for increased operator revenues without increased variable costs.

Various embodiment of the invention are discussed below, but before discussing those embodiments it should be recognized that as an event's start time approaches and the sale of space has been closed, the operator knows with certainty whether some space will remain unoccupied during the event. For operators, the prospect of empty space may mean not only a loss of revenue, but an increase in unit cost per passenger as well. Consider that airlines must expend funds to fly even empty seats and so the cost per passenger of operating a flight increases for each seat left empty prior to departure. The conventional approach to dealing with this situation is for the airline to try and fill seats, either by offering discounted rates as the time of departure approaches, or by permitting stand-by flyers (sometimes in exchange for a change fee). The former approach does little to alleviate the added cost per passenger of operating the flight and cannot be used once booking for the flight has closed (which in the case of international flights can be hours prior to departure). The latter does not always cure the situation (for example it may simply shift the empty seat problem to another flight) and does not always result in any increased revenue (e.g., if the passenger's existing ticket does not require that a change fee be paid). Both solutions, however, do inconvenience other passengers, who lose the opportunity to have the elbow room afforded by an EAS.

The conventional approach to offering passengers increased elbow room is to sell premium seating. For example, seats in “business” class or “first” class sections of an airplane or other vehicle are often wider and space between seats is often greater than that available in “economy” or “coach” classes. However, the additional cost associated with these seats is often prohibitively expensive for many passengers. Further, in uncertain economic times, companies often restrict or preclude the purchase of such premium seating by their employees. Consequently, these premium seats are often occupied by travelers that travel frequently and that can use non-cash means of compensation to purchase them. As a result, the airline does not enjoy increased revenue from providing the elbow room associated with the premium seats and again the cost per passenger of operating the flight increases. Likewise, an operator draws no additional revenue from those passengers who, by chance, are seated next to an empty space in a non-premium seating environment.

### DEFINITIONS

The following terms are used in connection with the present invention herein and in the claims following this description.
A. Adjacent Space: a recognized space for an event in the vicinity of a guest's assigned space for the event. For example, this can be a seat laterally adjacent to a guest's reserved seat, the two seats sometimes sharing an armrest (e.g., in a theatre or on an airplane). This can also be several physically adjacent seats, for example one or more on each side of a spectator's seat, or a row of contiguous seats on an airplane, train or other vehicle. This can also be a seat in front of or behind a guest's seat. Similarly, adjacent spaces may be vehicle parking spaces, boat harbor berths, aircraft parking spaces (e.g., on a tarmac or in a hanger) or other spaces depending on the nature of the event. Generally, a space is adjacent to a guest's assigned space if the occupancy of the subject space may affect a guest's experience and comfort at or during the event. For example, the seat(s) in front of (or behind) a guest's assigned seat in a theater or in an aircraft (which, if occupied, may block the guest's view or recline into the personal space of the guest), although not necessarily immediately adjacent thereto, are nevertheless adjacent spaces because whether or not the seat(s) is(are) occupied can materially impact the comfort and experience of the subject guest. Empty, unsold spaces can be sources of revenue for operators of the event.
B. Assigned Space: refers to a designated place or position associated with an event that is reserved for a guest. An assigned space can be a specific seat (typically identified by row and column or other designation), or block of seats (e.g., a row of seats), a specific berth in a sleeping cabin, a specific room in a building (e.g., a hotel, short-term residence, apartment complex, etc.), or, even more generally, any specific location in or associated with a facility where occupancy is determined on a space-assigned basis (e.g., camping sites, parking lots, ship harbors, marinas, aircraft hangers, storage for boats on land, personal property storage facilities, lockers, rooms in a hospital, real-estate lots, cemeteries, courts at a tennis club, chairs at a beach club, etc.).
C. Empty Adjacent Space (EAS): refers to space that has not, at the time of its sale, lease or other monetization, been assigned for any guest to occupy during the event and that is adjacent to a subject guest's assigned space. For example, an EAS can be an empty seat beside or in front of or behind a guest's seat in a theater or on a train, a bus, an airplane or another vehicle, or can be an empty berth above or below a guest's berth on a sleeper train, or can be an empty hotel room next to a guest's assigned room, or can be empty parking spaces around a guest's assigned parking space in a parking facility, or can be an empty berth next to a guest's boat's assigned berth in a harbor or a marina. The present invention involves providing one or more guests at an event a guarantee of an EAS relative to the guest(‘)s(’) assigned space. Note that a single EAS need not be allocated exclusively to one guest. For example, one empty middle seat in a row of seats on an aircraft can be sold as EAS upgrades to the two passengers seated on each side thereof as well as to the passenger seated behind the empty seat. Stated differently, the availability of unsold space (hitherto considered spoiled inventory) affords the operator of an event multiple vectors by which to derive revenue from the subject space and provide the convenience of EAS for multiple guests at the same time. Various operators' EAS upgrade policies may determine how guests may share EAS. For example, an airline may physically repurpose an empty middle seat using a divider in the middle of the seat or two storage devices that each occupy one half of the empty seat to signify that it is to be enjoyed by two passengers adjacent the empty seat.
D. Event: refers to any activity having an associated assigned space (e.g., seating, berthing, cabin assignment, room, apartment, vehicle parking, aircraft parking, watercraft parking on land or berthing in water, etc.). The event can be a theater play, an airline flight, a train ride, a coach/bus ride, a trip on a waterway ship, a hotel stay, an apartment lease, a parking space lease, a hospital stay, a boat harbor berth lease, a beach-chair or beach-mattress rental, an aircraft hangar space lease, a cemetery plot lease or purchase, a real-estate plot lease or purchase, etc.
E. Guest: refers to persons for whom assigned space is reserved. Depending on the nature of the event, guests may be passengers, spectators, event-goers, occupants, residents, owners/users of vehicles, or owner of personal property: In general, guests are those who use assigned spaces at an event. For simplicity it is herein assumed that the person or entity paying for the assigned space is also the person using the assigned space. While a distinction could be made between these individuals (and may be appropriate insofar as marketing of EAS opportunities is concerned), we will simply refer to both as guests.
F. Operators: are those who provide assigned space to guests who wish to attend an event. Operators need not be the individuals or entities performing the event although for simplicity it is herein assumed that both roles are assumed by a single entity. By way of example, the operator can be an airline that provides seats to passengers, or an airfield providing aircraft parking space in a hangar, or an opera house providing seats to patrons, etc. Operators can also be a group of partnering entities, for example, a train line may operate trains while a different entity may sell space on the train and still a different entity may sell EAS upgrades at check-in time.

With the above in mind, we turn to a discussion of various embodiments of the present invention. As noted above, as the start time of an event approaches and the sale of assigned spaces for the event has been closed, it is often the case that some spaces will remain empty during the event (e.g., over its entire duration or at least for some period of time during the event). The present invention allows operators and/or guests to identify which of those otherwise empty spaces are EAS and to sell/purchase the EAS for the event. We examine these activities according to an assess/sell/assign/differentiate & repurpose methodology.

Assess Space Available: The assessment phase of the process is used to determine whether or not any EAS exists for a given event. In general, one can use a space-allocation information system (IS) to determine what space(s) is(are) not assigned spaces and, hence, will remain empty (unoccupied) during the event (or at least the portion thereof under consideration). The space-allocation IS can be implemented by electronic (e.g., an airline or a theater reservation system), mechanized (e.g., colored magnets on a board to represent occupied spaces), or manual (e.g., paper records of occupied spaces in a marina or in an aircraft hangar) means. The assessment can rely on a visual or physical survey of available spaces that are not assigned.

Sell EAS Upgrades: In this phase of the process, guests are provided the opportunity to purchase a guarantee that their assigned space will be adjacent one or more EAS (e.g., beside, in front of, behind, above or below, as appropriate, the guest's assigned space). The guarantee (that is, the upgrade) may be for the entire duration of the event (e.g., as with a theater performance or an airline flight), or it may last for a designated part of the event (e.g., an empty-adjacent-apartment upgrade in an apartment building or an empty-adjacent-boat berth upgrade in a marina may be proffered on a monthly (or other) basis in conjunction with a longer term lease).

Assign Space: This is an optional, but common, process which finalizes the assignment of guests to space. In assigned-space environments, this process typically matches each guest with a certain space in/at the event. The final stage of this process usually takes place at check-in time and this is typically where the operator has the opportunity to match guests who purchased EAS upgrades with empty space, i.e., to ensure that available unsold space is located adjacent to the guest's assigned space.

Optionally: Differentiate and/or Repurpose Reserved EAS: In some instances, the operator may physically differentiate the available space that is sold as guaranteed EAS in order to:
A. Make the EAS more useable as extra space. This may involve repurposing the space and enhancing it for its new purpose, for example by installing means for storing personal effects or a pad to allow a passenger to comfortably occupy the EAS.
B. Reward guests who upgraded. This may be accomplished by providing extra amenities, for example snacks, dinks or toiletry items, or providing advance boarding or priority luggage service to those passengers who upgraded.
C. Block space that should remain empty to prevent it from being occupied. For example the operator may designate that a seat or other space should remain unoccupied by use of a sign or other means (e.g., a stuffed animal or other means) to prevent access to the guaranteed EAS. This is especially important in free-seating (no space assignment) settings such as movie theatres.
D. Advertise the EAS as being reserved empty space for other guests to see. This may encourage other guest to purchase EAS upgrades in the future.

By repurposing space and/or providing rewards for upgrading, operators may be able to monetize more EAS upgrades than might otherwise be the case, for example by cresting a sense of urgency among passengers or appealing to passengers' needs. Physically repurposing empty space sold as EAS can also help enforce an operator's policies regarding upgrades. For example if an operator reserves the right to sell a middle seat as guaranteed EAS to guests on both sides of the middle seat, the physical repurposing of the middle seat into two halves may remind both passengers of the need to share the EAS.

In various embodiments, the present invention may be practiced by operators as a means to provide EAS upgrades to guests directly. Alternatively, the invention may be practiced by third parties acting as an intermediary between operators and guests. For example, third parties may purchase EAS inventory in bulk from operators once and sell the EAS upgrades to guests on an individual (e.g., retail) basis from that inventory.

The methods and systems of the present invention are applicable to any event with assigned spaces, where operators will be aware with some certainty some time prior to the start time of the event whether or not EAS exist. This includes a large number of possible use scenarios, including: events involving transportation (e.g., by air, rail, road, or water), performance (e.g., at theatres or other venues), sporting contests (e.g., where assigned spaces are provided), and so on.

Several sales channels for the provision of EAS upgrades exist. For example, direct sales conducted on a first-come-first-served basis, where the available inventory of empty space is depleted as EAS upgrades are sold by the operator or third party can be used. In this model, the price of EAS upgrades need not remain static and in fact may increase as the available inventory of EAS is depleted and/or as start time of the event approaches. Of course, the price of EAS may also vary from one event to another. Alternatively, the sale of EAS upgrades may be conducted by way of an auction (with or without reserve) where, instead of the operator setting a price, guests may bid for EAS upgrades. In some instances, the auction may be a reverse auction, where the operator (or third party responsible for monetizing the EAS on behalf of the operator can accept or reject a bid. Note that although the term “upgrade” is being used to describe EAS sales (as the concept is a familiar one to most travelers), EAS need not be sold on an upgrade basis. That is, EAS may be sold (or leased) as one of many options.

EAS may be offered to guests participating in a social event (e.g., a dining event) as part of an “affinity” program, for example based on gender, religion, sexual orientation, national origin, marital status, parental status, age group, common interest, etc. Alternatively, EAS may be offered as part of a “quiet” section for passengers, tenants or occupants sharing a desire to remain undisturbed during an event, that is “unoccupied” adjacent space may not be physically unoccupied, but rather not occupied by a certain type of guest (e.g., a passenger with a young child or infant).

An alternative embodiment of the invention provides a “reverse-EAS” model. For example, operators may reward/compensate guests willing to accept assigned space in areas with no EAS. This may allow an airline to maximize the number of passengers on a given flight by enticing people to accept middle seat assignments in exchange for some form of reward (e.g., loyalty points, coupons for meals, drinks or other goods or services, etc.).

A further alternative embodiment of the invention allows for the provision of occupied adjacent space (“OAS”). For example, seating at full tables may be more valued in settings where guests value relationships, networking and meeting people more than they value EAS. Accordingly, the methods of the present invention allow operators to guarantee OAS to guests at such events and such spaces may be sold at a premium or as an upgrade.

In general, EAS configurations may accommodate immediately adjacent spaces, spaces immediately forward or behind a guest's assigns space, or multiple instances of either or both such spaces. EAS may include an entire unoccupied space or just a portion thereof (e.g., in a situation where the EAS is shared among more than one guest or where the EAS can be partitioned in some fashion). EAS guarantees may be priced according to the overall availability of EAS for the event, the duration of the event, the kind or nature of the EAS, or in another fashion (e.g., a fixed price irrespective of the number of available EAS).

In some instances, an operator of a long-duration, dense space event may choose to sell EAS upgrades for only designated portions of the event. For example, an airline operator may repurpose a row of seats into a sleeper and sell access to those repurposed empty seats to several passengers who would then take turns using the space and who may pay by the hour or on some other basis.

Preferably, EAS upgrades are made available for purchase at the time of check-in, but more generally the EAS may be made available at any time after the operator can be certain that some spaces will remain unoccupied during the event. Accordingly, some operators may choose to offer EAS upgrades to guests prior to check-in time, for example at the time a reservation is made, or at any time prior to the event commencement time. While such scenarios may complicate the reservation process (for example, because an operator would need to estimate with very good accuracy the availability of EAS well in advance of an event, or may have to set a desirable rate of occupancy, also known as a “load factor”, and then prevent some space from being sold as assigned space to preserve same for EAS upgrades), guests may gravitate towards operators willing to provide EAS guarantees well in advance of an event start time and may be willing to pay sufficiently high prices for same so as to make the effort worth while on the part of the operator.

One possible consequence of the invention is to alter the marginal cost calculation by introducing an opportunity cost, therefore, in some cases inducing operators to purposefully leave empty capacity at certain events. For example, in a crowded theatre, where most if not all seats have already been sold for a performance, it may make more financial sense for the theatre operator to reserve the remaining empty seats for sale as EAS, if such sales would generate more revenue than the sale of the seats themselves. Likewise, an airline may actually derive more revenue from the sale of EAS than from the sale of seats to new passengers, if the passengers already booked on the flight are likely to purchase EAS upgrades. Thus, providing means of notifying guests of the availability of EAS (for example, using email or short message service (SMS) alerts, or a seating chart positioned near an embarkation point and showing a real time view of the occupied seats at an event) may be a useful way of creating a sense of urgency among guests and spurring the purchase of EAS.

The present invention requires only that an operator (or third party acting on behalf of the operator) maintain some form of available space assignment process (ASAP). For example, this could be an airline, theater or hotel reservation system that provides insight into the currently assigned space for an event and an indication of where such spaces are in relation to EAS. Likewise, a marina managing boat berths, or an airport managing aircraft parking and storage space, or an apartment manager tracking the assignment of apartment units in a building, etc., can all be expected to track these conditions and have some knowledge of the availability and location of EAS vis-à-vis assigned spaces.

Likewise, it is helpful if the operator (or the third party acting on behalf of the operator) has some means of indicating that EAS that has been purchased by a guest remains unoccupied. In the simplest case, this may be an object (such as a sign or other indicator) deposited on a seat or otherwise associated with a space that alerts other guests and event staff that the EAS is reserved. Alternatively, seating charts or similar means that are viewable by guests may be marked to indicate that EAS has been purchased and is no longer available.

The ASAP may be automated (e.g., through the use of appropriately programmed electronic computer means or, more generally, a space-allocation information system (IS)) in order to continually assess how much space will remain empty during an event. The ASAP may also include means for selling EAS upgrades according to operator policies (e.g., business rules). For example, on commercial airline flight with a large number of unsold seats, the ASAP may be configured to not offer any EAS upgrades (the operator's business rules indicating that it is more beneficial to try to sell the unoccupied seats at their regular price than as EAS upgrades), whereas on flights that have relatively few available seats (or, as is often the case, are oversold for the number of available seats) the ASAP may be configured to offer EAS upgrades as the flight's departure time approaches.

The ASAP may also be configured to price EAS upgrades. Such pricing may depend on several factors, including, but not limited to, the amount of space anticipated to remain empty during the event, the duration of the event, the density of space in a section of the event, etc. For example, EAS upgrades may be sold at prices depending on the anticipated proportion of empty space for the entire event, or its sections, and/or taking into account the duration of the event. Based on the proportion of empty space, the ASAP may increase the quantity of EAS offered, for example on a lightly-loaded flight, the ASAP may sell entire rows of seats (as opposed to individual seats) as EAS upgrades. This will not only increase passenger comfort, but also increase the incentive for passengers to purchase EAS upgrades (as their chance of getting random EAS will rapidly diminish as entire rows of seats are reserved for EAS upgraders).

The means for offering EAS upgrades may vary depending on the nature of the event. For example, with airline flights, EAS upgrades may be offered through self-service kiosks used by passengers to obtain boarding passes, or by airline personnel using computer systems at check-in or gate stations. At theatres, EAS upgrades may likewise by offered through self-service kiosks at which guests obtain tickets, or by theatre personnel using computer systems at the ticket window. Similar models may be used at train stations, bus stations, or other transportation-related venues. The same is true for automated parking lots and the like. Apartments, hospitals, hotels, or other venues where rooms and the like are used as EAS upgrades may rely on personal sales as these venues are not typically associated with self-service kiosks.

The present invention may also be used by operators that do not offer assigned spaces for their guests. For example, some airlines employ an open seating model, where passengers are permitted to occupy any seat after boarding the aircraft. Nevertheless, EAS can still be offered and the passenger may be provided with means (e.g., a sign or other means) to identify a reserved EAS that can be positioned once the passenger chooses a seat.

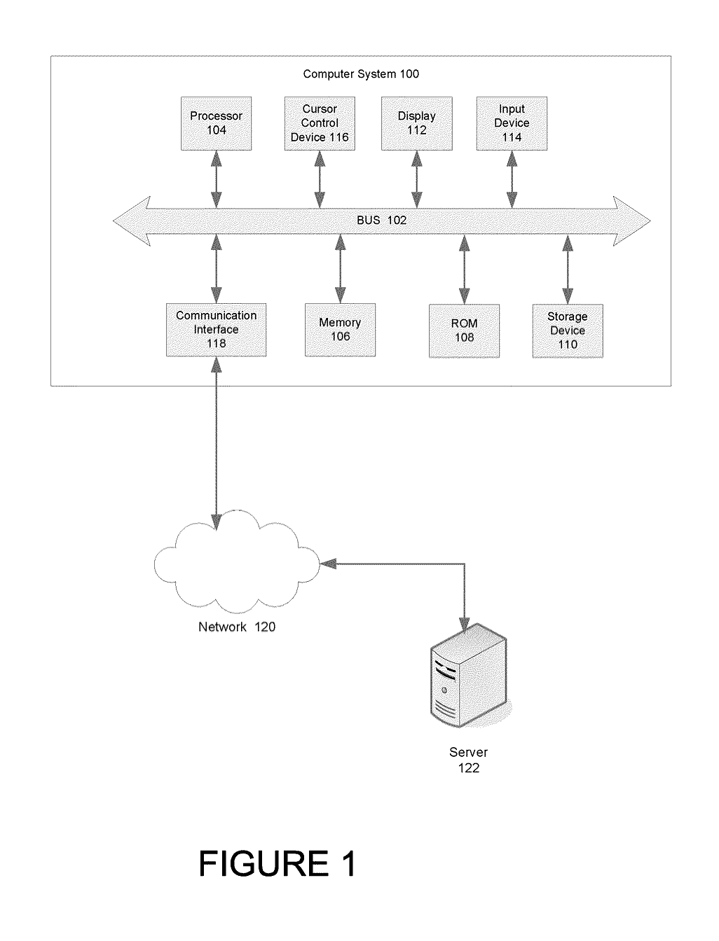

Referring now to FIG. 1, a block diagram illustrating an exemplary computer system 100 upon which an embodiment of the invention may be implemented is shown. The present invention is usable with currently available computer systems, provided that they are configured with programming that implements the methods described herein. For example, existing airline, hotel, or other reservation systems may be reconfigured in accordance with the methods discussed herein to permit the purchase and sale of EAS.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk (e.g., a floppy disk, a flexible disk, a hard disk, or any other magnetic medium) or optical disk (e.g., a CD-ROM, a DVD-ROM, any other optical medium), or a solid-state storage device such as a FLASH memory, or other form of storage device, is provided and coupled to the bus 102 for storing information and instructions (such as the instruction to implement the methods discussed herein).

Computer system 100 may be coupled via the bus 102 to a display 112, such as a liquid crystal display (LCD), for displaying information to a user of computer system 100. An input device 114, including an alphanumeric or other keyboard or touch-sensitive device (such as a touch screen or tablet), is coupled to the bus 102 for communicating information and command selections to the processor 104. Another type of user input device is cursor control device 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a geometric plane.

According to one embodiment of the invention, sequences of instructions which define the methods of the present invention in computer-readable language are contained in storage device 110 and, during execution, are read in to main memory 106 (e.g., under the control of the processor or another memory access unit) and then executed by processor 104. Execution of the sequences of instructions contained in the main memory 106 causes the processor 104 to perform the process steps described herein. In alternative embodiments, hard-wired circuitry may be used in place of or in combination with computer software instructions to implement the invention. Thus, embodiments of the invention are not limited to any specific combination of hardware circuitry and software.

Computer system 100 may also includes a communication interface 118 coupled to the bus 102. Communication interface 118 provides a two-way data communication between computer system 100 and a computer network, such as a local area network (LAN) 120. Communication interface 118 may provide a wired and/or wireless communication path to/from LAN 120. LAN 120 may itself be communicatively coupled to further computer networks (such as the Internet), although such communication paths are not shown in detail so as not to unnecessarily complicate the drawing.

Computer system 100 can send messages and receive data, including program code, through communication interface 118. Thus, a server 122 might act as a repository for the sequences of instructions which define the methods of the present invention in computer-readable language and the computer system 100 may download the instructions from the server for execution locally, or pass information to/from the server to permit the server to perform the process of the present invention as described herein.

The computer-implemented processes or methods (a.k.a. programs or routines) by which the methods of the present invention are defined may be rendered in any computer language including, without limitation, C#, C/C++, Fortran, Java, JavaScript, Visual Basic, COBOL, PASCAL, assembly language, markup languages (e.g., HTML, SGML, XML, VoXML), and the like, as well as object-oriented environments such as the Common Object Request Broker Architecture (CORBA), J2EE, Microsoft Net, and the like. In general, however, all of the aforementioned terms as used herein are meant to encompass any series of logical steps performed in a sequence to accomplish a given purpose. Terms such as “processing”, “computing”, “calculating”, “determining”, “displaying” or the like, when used in conjunction with the description of the invention, are intended to refer to the action and processes of a computer system such as computer system 100, or a similar electronic computing device, that manipulates and transforms data represented as physical (electronic) quantities within the computer system's registers and memories into other data similarly represented as physical quantities within the computer system memories or registers or other such information storage, transmission or display devices. These electronic quantities represent physical world objects, such as EAS, assigned spaces and the like.

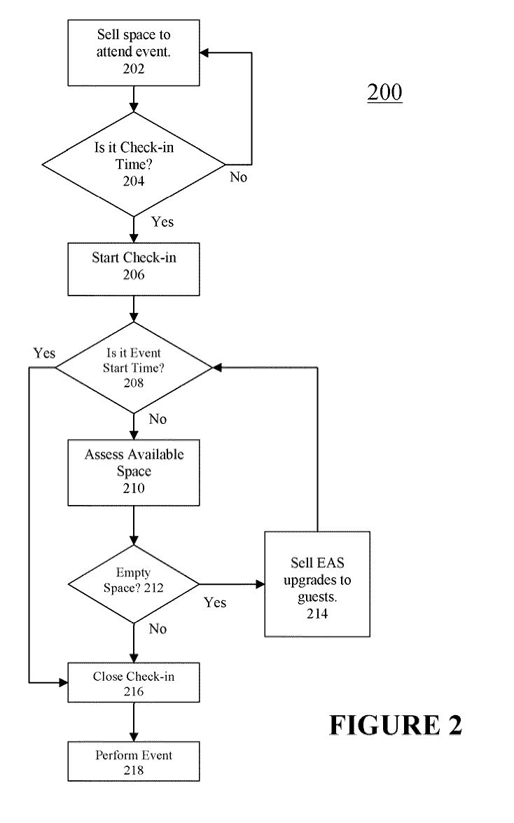

FIG. 2 is a flow diagram showing an exemplary embodiment of the invention, as for example may be used in connection with the sale of EAS associated with an airline flight or other event. Process 200 begins with the sale of assigned spaces to guests intending to attend an event (202), As indicated above, this may be any form of event and all that is required is that the operator (or a third party acting on the operator's behalf) have some means of tracking the sale of assigned spaces (though not necessarily the actual location of such spaces at the event, e.g., in the case of airlines that do not provide assigned seating). This may be a computer system such as computer system 100, operating according to appropriate programming, or another means.

The sale of assigned spaces continues until check-in time (or some other designated time in advance of the event start time (204). Thereafter, the check-in process commences (206). During the check-in process (or, in some cases, after the check-in process has concluded), and before the event start time (208), an assessment is made of the available, unassigned space (210). If unsold space exists (212), it is sold as EAS upgrades to guests (214). This may continue for so long as available space exists prior to the event start time. Eventually, however, the check-in period will close (216) and/or the available empty space inventory will be depleted, and sometime thereafter the event will commence (218).

Some examples of EAS configurations are now provided to help the reader more fully appreciate aspects of the present invention. These examples, which are directed to vehicle seating assignments (e.g., on a train, bus or aircraft) and resulting EAS opportunities, are not intended to be limiting.

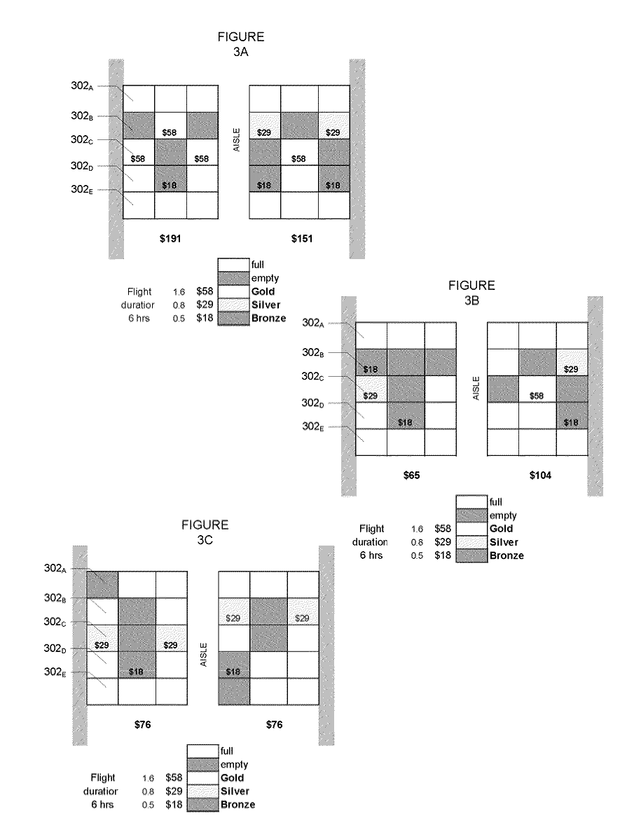

In FIG. 3A, a section of aircraft seats consisting of five rows of seats 302_{A}-302_{E}, with each row configured 3×3 and having a central aisle, is shown. Twenty percent of the seats remain unsold. This is typical of the 80% overall average load factor on major U.S. commercial airline flights. In the figure, “Gold” EAS opportunities are deemed to be those which are laterally adjacent to two EAS areas and are also immediately behind an EAS area. These are deemed to be the sources of highest possible revenue. Seats positioned laterally adjacent to one EAS area may be deemed sources of the next highest possible revenue (“silver” opportunities), and seats positioned in front of an EAS area may be deemed sources of the least highest possible revenue (“bronze” opportunities). FIGS. 3B and 3C show that for the same five row section of seats, but different configurations of EAS, different revenues from the sale of EAS are obtained. These example shows how pricing these different EAS opportunities (e.g., gold at $58, silver at $29, bronze at $18) may derive revenues of different amounts for various configurations of EAS locations. Of course, different pricing models may be used and the examples shown in the illustration are merely for purposes of explanation. For example, pricing could vary by trip duration, by load factor, by market, by time of day or year, etc.

Thus, methods and systems facilitate the sale, lease, rental, or other monetization of unsold space inventory (e.g., seats, berths, cabins, rooms, etc.) to customers or passengers as guaranteed, empty adjacent space have been described.

What is claimed is:

1. A method, comprising following expiration of a time period for guests to purchase assigned space for an event, determining whether or not any unsold space for the event exists, and, if so, offering the unsold space as empty adjacent space (EAS) for purchase by one or more guests holding assigned space for the event so as to guarantee that the EAS remains unoccupied during at least a portion of the event.

2. The method of claim 1, wherein the EAS comprises at least one of the following: a seat, a berth, a room, a cabin, a parking space, a designated space for a passenger on a vehicle, a designated space for personal property, and a designated space in a building.

3. The method of claim 1, wherein the event comprises at least one of the following: a voyage, a flight, a lease term, a theatre performance, a hotel stay, and a period of occupancy of an assigned space.

4. The method of claim 1, wherein determining whether or not any unsold space for the event exists occurs after a check-in process for the event has commenced.

5. The method of claim 1, wherein the EAS is laterally adjacent to an assigned space for at least one of the one or more guests.

6. The method of claim 1, wherein the EAS is located in front of or behind an assigned space for at least one of the one or more guests.

7. The method of claim 1, wherein the EAS is located above or below an assigned space for at least one of the one or more guests.

8. The method of claim 1, wherein a common EAS area for the event is offered to multiple ones of the one or more guests for purchase.

9. The method of claim 1, further comprising repurposing purchased ones of the EAS.

10. The method of claim 9, wherein repurposing comprises subdividing purchased ones of the EAS for use by those of the one or more guests purchasing common ones of the EAS.

11. The method of claim 1, further comprising designating purchased ones of the EAS as guaranteed EAS not to be occupied.

12. The method of claim 1, wherein the EAS is offered for purchase according to business rules established by an operator of the event.

13. A system, comprising
means for determining, following expiration of a time period for guests to purchase assigned space for an event, whether or not any unsold space for the event exists, and
means for offering the unsold space for purchase as empty adjacent space (EAS) by one or more guests holding assigned space for the event so as to guarantee that the EAS remains unoccupied during at least a portion of the event.

14. The system of claim 13, wherein the EAS comprises at least one of the following: a seat, a berth, a room, a cabin, a parking space, a designated space for a passenger on a vehicle, a designated space for personal property, and a designated space in a building.

15. The system of claim 13, wherein the event comprises at least one of the following: a voyage, a flight, a lease term, a theatre performance, a hotel stay, and a period of occupancy of an assigned space.

16. The system of claim 13, wherein the means for determining is configured to determine whether or not any unsold space for the event exists after a check-in process for the event has commenced.

17. The system of claim 13, wherein the EAS is located laterally adjacent to, in front of, behind, above or below an assigned space for at least one of the one or more guests.

18. The system of claim 13, wherein the means for offering is configured to offer a common EAS area for the event to multiple ones of the one or more guests for purchase.
